(19) United States
(12) Patent Application Publication
(10) Pub. No.: US 2013/0221904 A1
(43) Pub. Date: Aug. 29, 2013

(54) TERMINAL AND METHOD FOR CHARGING BATTERY OF SUB TERMINAL CONNECTED TO MAIN TERMINAL

(71) Applicant: PANTECH CO., LTD., (US)

(72) Inventor: Se-Gu KANG, Ansan-si (KR)

(73) Assignee: PANTECH CO., LTD., Seoul (KR)

(21) Appl. No.: 13/693,668

(22) Filed: Dec. 4, 2012

(30) Foreign Application Priority Data
Feb. 29, 2012 (KR) 10-2012-0021453

(51) Int. Cl. H02J 7/00

(52) U.S. Cl. CPC H02J 7/0022; H02J 7/007
USPC 320/107; 320/162

(57) ABSTRACT

A main terminal including a connection unit connectable to a subordinate terminal, a charging unit to charge a first battery of the main terminal and to charge a second battery of the subordinate terminal, and a control unit to maintain a first charging current to the main terminal regardless of whether a second charging current is provided to the subordinate terminal. A method for controlling a charging current for a subordinate terminal connected to a main terminal including recognizing a voltage of a battery of the subordinate terminal, determining a charging current for the battery of the subordinate terminal, and providing the charging current to the battery if the voltage of the battery is less than or equal to a target voltage.

### CROSS-REFERENCE TO RELATED APPLICATION

This application claims priority from and the benefit under 35 U.S.C. §119(a) of Korean Patent Application No. 10-2012-0021453, filed on Feb. 29, 2012, which is incorporated herein by reference for all purposes.

### BACKGROUND

1. Field

The following description relates to a battery charging apparatus and method, and more particularly, to an apparatus and method for charging a battery of a sub terminal connected to a main terminal.

2. Discussion of the Background

Portable electronic devices have become necessities of modern life and continuous technical development has enabled them to be smaller, lighter, and capable of providing various functions, e.g., music player for MP3 file format, camera, navigation, etc. A portable electronic device receives power supplied from a secondary battery, such as a lithium ion battery or lithium polymer battery. Hence, before the battery is fully discharged, the portable electronic device may need to be recharged so that a user can normally use all functions of the portable electronic device.

A portable electronic device may perform functions of a complex terminal, and may have a separate sub terminal through which various functions can be provided to the user. For example, a portable electronic device having a relatively large volume, such as a laptop computer, touch panel or personal digital assistant (PDA), may communicate with a sub terminal having a relatively small volume for performing operations of a telephone, etc.

If the portable electronic device is configured with a main terminal having a relatively large volume and a sub terminal having a relatively small volume, two chargers may be required to charge batteries of the main terminal and the sub terminal, respectively. However, if the two chargers are separately provided with the portable electronic device, the configuration of the portable electronic device may be complicated and less efficient since two separate charger connectors and charging circuits are provided. Furthermore, since two outlets are occupied for the respective chargers, it may be inconvenient to charge the two terminals when the user is on the move or when there are insufficient outlets available.

The above information disclosed in this Background section is only for enhancement of understanding of the background of the invention and therefore it may contain information that does not form any part of the prior art nor what the prior art may suggest to a person of ordinary skill in the art.

### SUMMARY

The following description relates to an apparatus and method for charging a main terminal and sub terminal using a single charger.

The following description also relates to an apparatus and method for charging a sub terminal using a main battery of a main terminal connected to the sub terminal.

Additional features of the invention will be set forth in the description which follows, and in part will be apparent from the description, or may be learned by practice of the invention.

Exemplary embodiments of the present invention provide a main terminal including a connection unit connectable to a subordinate terminal, a charging unit to charge a first battery of the main terminal and to charge a second battery of the subordinate terminal, and a control unit to maintain a first charging current to the main terminal regardless of whether a second charging current is provided to the subordinate terminal.

Exemplary embodiments of the present invention provide a main terminal including a connection unit connectable to a subordinate terminal, a charging unit to charge a first battery of the main terminal and to charge a second battery of the subordinate terminal, and a control unit to provide a charging current to the subordinate terminal if a remaining battery power of the first battery is greater than a threshold battery power.

Exemplary embodiments of the present invention provide a method for controlling a charging current for a subordinate terminal connected to a main terminal including recognizing a voltage of a battery of the subordinate terminal, determining a charging current for the battery of the subordinate terminal, and providing the charging current to the battery if the voltage of the battery is less than or equal to a target voltage.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a main terminal and a sub terminal according to an exemplary embodiment of the present invention.

FIG. 2 is a block diagram illustrating a configuration of a main terminal and a sub terminal according to an exemplary embodiment of the present invention.

FIG. 3 is a flowchart illustrating a method for charging a main terminal according to an exemplary embodiment of the present invention.

FIG. 4 is a flowchart illustrating a method for charging a sub terminal when a charger is coupled to a main terminal according to an exemplary embodiment of the present invention.

FIG. 5 is a flowchart illustrating a method for charging a sub terminal when a charger is not coupled to a main terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

According to aspects of the present invention, a main terminal may include devices including not only mobile communication terminals, such as a personal digital assistant (PDA), a smart phone, and a navigation terminal, but also personal computers, such as a desktop computer and a laptop computer. Further, the main terminal may simultaneously charge its own main battery and a battery of a sub terminal. The sub terminal may be a smaller-sized terminal or a terminal for performing supplemental operations or dedicated functions of the main terminal, or may be a terminal for performing operations of a light or portable terminal, which are not performed by the main terminal. Further, the main terminal and the sub terminal may have a configuration in which the main terminal and the sub terminal are to be charged by a single charger or the battery of the sub terminal is to be charged by the battery of the main terminal.

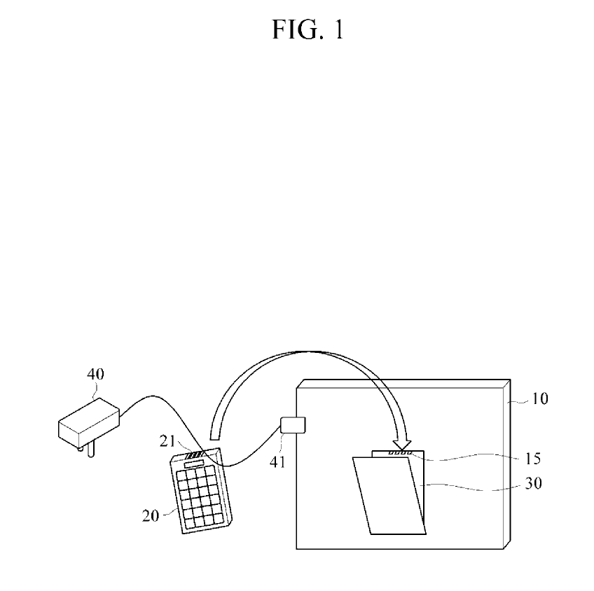

FIG. 1 is a diagram illustrating a main terminal and a sub terminal according to an exemplary embodiment of the present invention.

A main terminal 10 may include a space 30 so that a sub terminal 20 can be attached/detached to/from the main terminal 10 via the space 30. As shown in FIG. 1, the space 30 may accommodate the sub terminal 20 into an inner space of the main terminal 10. A connection unit 15 of the main terminal 10 may be disposed on one side of the space 30 and may be connected to a connection unit 21 of the sub terminal 20 to transmit a control signal and a battery charging current to the sub terminal 20 may be provided via the connection unit 15. The connection unit 21 may be disposed at one side of the sub terminal 20.

Further, the main terminal 10 and the sub terminal 20 may be connected via a separate connector. For example, a separate cable, or a connection unit through which the main terminal is connected to the sub terminal may be formed at one external side of the main terminal. Further, the sub terminal 20 may be charged via the main terminal 10 based on an inductive charging method without a wired connection with the main terminal 10 if inductive charging circuits are provided in the sub terminal 20. Further, the sub terminal 20 may have the same configuration as the main terminal 10, and thus two main terminals 10 may be connected and one of the two main terminals 10 may be charged via the other main terminal 10. Further, more than two terminals may be connected in a series connection and one main terminal 10 may charge more than two sub terminals 20. Further, a main terminal may refer to a terminal connected to a charger and provide power to other terminals, and a subordinate terminal (or “sub terminal”) may refer to a terminal connected to a main terminal to receive power to charge its own battery through the main terminal.

The connection unit 15 or the connection unit 21 may include one or more physical connection pins. The connection pins may include a recognition pin for detecting a connection and the capacity of a battery in the sub terminal 20, a power pin for detecting a voltage of the battery of the sub terminal 20, and a ground (GND) pin for constantly maintaining reference voltages of the main terminal 10 and the sub terminal 20. The connection pin may further include a temperature pin for detecting a temperature of the sub terminal 20. It may be determined whether the sub battery is in a chargeable state according to the temperature of the sub terminal 20, which may be detected by the temperature pin. If the sub terminal 20 is overheated, it may be determined that the charging condition of the sub battery is not satisfactory. The connection unit 15 or the connection pin 12 may be designed to have three pins without including the temperature pin or four pins including the temperature pin.

A port 41 through which an external charger 40 can be connected to the main terminal 10 may be disposed at one side of the main terminal 10, so that the battery of the main terminal 10 and the battery of the sub terminal 20 can be charged by the charger 40.

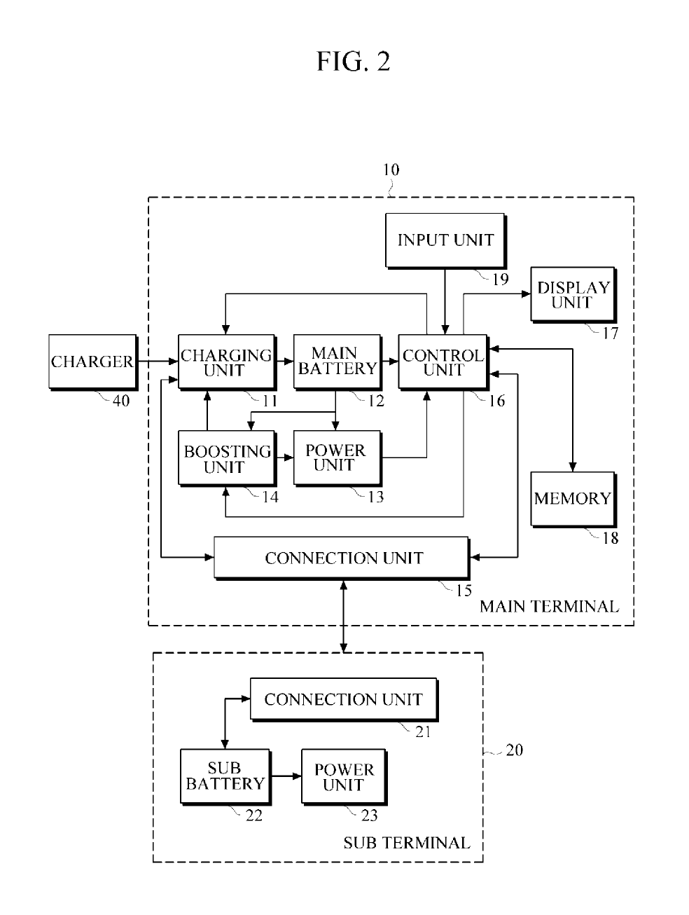

FIG. 2 is a block diagram illustrating a configuration of a main terminal and a sub terminal according to an exemplary embodiment of the present invention.

Referring to FIG. 2, a main terminal 10 includes a charging unit 11, a main battery 12, a power unit 13, a boosting unit 14, a connection unit 15, and a control unit 16. Further, the main terminal 10 may include a display unit 17, a memory 18, and an input unit 19.

A charger 40 may be connected to the charging unit 11 so as to charge the main battery 12 and a sub battery 22 under the control of the control unit 16. A charging current ‘Im’ that flows into the main battery 12 may be determined by the control unit 16, and the charging current ‘Im’ may be input to the main battery 12 from the charging unit 11. The charging unit 11 may charge the main battery 12 with the charging current ‘Im’. If a signal that the main battery 12 has been fully charged is input from the control unit 16, the charging unit 11 may terminate the charging of the main battery 12.

Further, the charging current ‘Is’ that flows into the sub battery 22 may be determined by the control unit 16, and the charging unit 11 may provide the charging current ‘Is’ to the sub battery 22 through the connection units 15 and a connection unit 21. If both the main battery 12 and the sub battery 22 are being charged, the charging unit 11 may provide a charging current ‘Ims’ to provide the charging current ‘Im’ in the main battery 12 and the charging current ‘Is’ to the sub battery 22. The charging current ‘Ims’ may correspond to a value obtained by adding the charging current ‘Is’ provided to the sub battery 22 and the charging current ‘Im’ provided to the main battery 12. If the sub battery 22 is connected and charged with the main battery 12, the charging unit 11 may provide a higher net current, the charging current ‘Ims’, to maintain the magnitude of the charging current ‘Im’ that flows into the main battery 12.

For example, the sub battery 22 may be recognized while the main battery 12 is being charged with a current of 1000 mA. If the sub battery 22 is charged with a charging current of 200 mA, the control unit 16 controls the sub battery 22 to be charged with the current of 200 mA while maintaining the main battery 12 to be charged with a current of 1000 mA. The current of 1200 mA is a value obtained by adding the current of 200 mA flowing into the sub terminal 20 to the current of 1000 mA flowing into the main battery 12 of the main terminal 10. The charging current ‘Ims’ may flow into the main battery 12 and the charging current ‘Is’ may flow into the sub battery 22 from the main battery 12. Further, the charging current ‘Ims’ may be divided into the charging current ‘Im’ that flows into the main battery 12 and the charging current ‘Is’ that flows into the sub battery 22.

As the voltage of the sub battery 22 increases toward a fully charged voltage level, the charging current ‘Is’ of the sub battery 22 may gradually decrease. The control unit 16 may control the current provided to the main battery 12 to decrease the charging current ‘Is’ provided into the sub battery 22 if the charging current ‘Is’ is provided from the main battery 12. Thus, the charging current of the main battery 12 may be maintained constant.

The main battery 12 may be manufactured in an attachable/detachable or connectable type, and may be a rechargeable battery. The main battery 12 may be mounted in an inner space provided inside of the main terminal 10, and may be covered by a housing for protecting and fixing the main battery 12. The main battery 12 may transmit a recognition signal to the control unit 16 if the main battery 12 is connected to the main terminal 10. Then, the control unit 16 may control the main battery 12 to be charged up to a certain voltage by checking the voltage of the main battery 12.

The power unit 13 may supply and cut off power to/from the control unit 16 by converting the voltage across the main battery 12 into power, and may control the power to be supplied to another component under the control of the control unit 16 after supplying power to the control unit 16. For example, if a power key is pressed when the main terminal 10 is turned off, the power unit 13 supplies power from the main battery 12 to each of the components (e.g., the charging unit 11, the main battery 12, the boosting unit 14, the connection unit 15, the display unit 17, the memory 18, the input unit 19, and the like) in the main terminal 10 through the control unit 16. If the power key is pressed when the main terminal 10 is turned on, the power unit 13 may stop the power supply by blocking an electrical signal line connected to the main battery 12.

The boosting unit 14 may change a charging voltage so that the value of the charging current input by the charging unit 11 is controlled by the control unit 16. The control unit 16 may control the boosting unit 14 to increase the charging current of the main battery 12 to the charging current ‘Ims’ obtained by adding the charging current ‘Is’ for the sub battery 22 to the charging current ‘Im’ for the main battery 12 according to the charging current ‘Is’ of the sub battery 22.

The connection unit 15 may be connected to the connection unit 21 of the sub terminal 20 to connect the sub battery 22 to the charging unit 11 or the control unit 16. The connection unit 15 may include a plurality of connection pins. The connection pins may have the same configuration as the connection pins of the connection unit 15 described above with respect to FIG. 1.

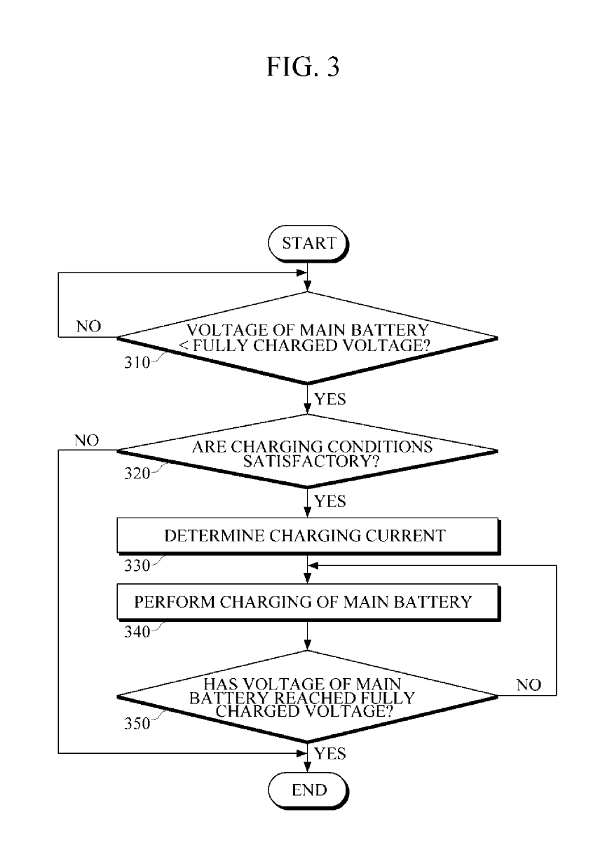

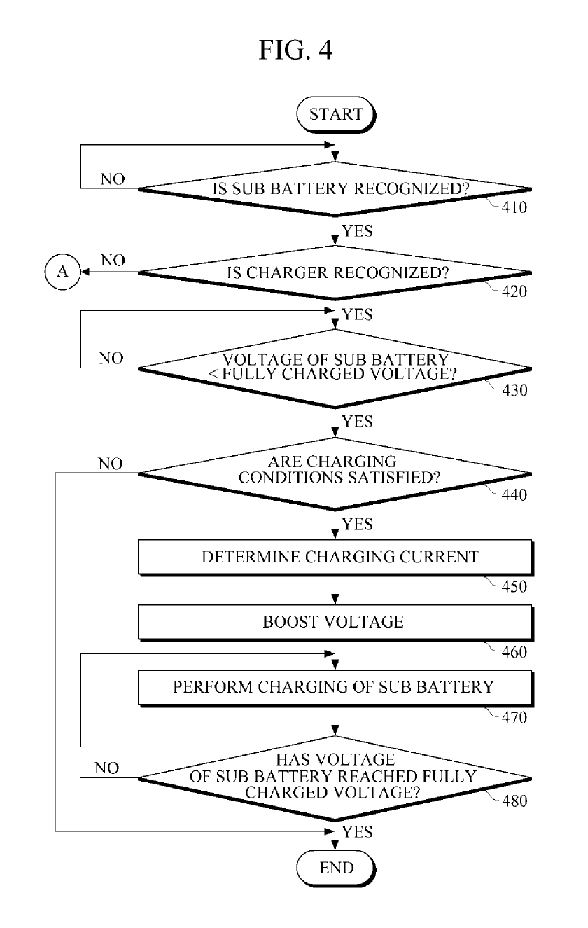

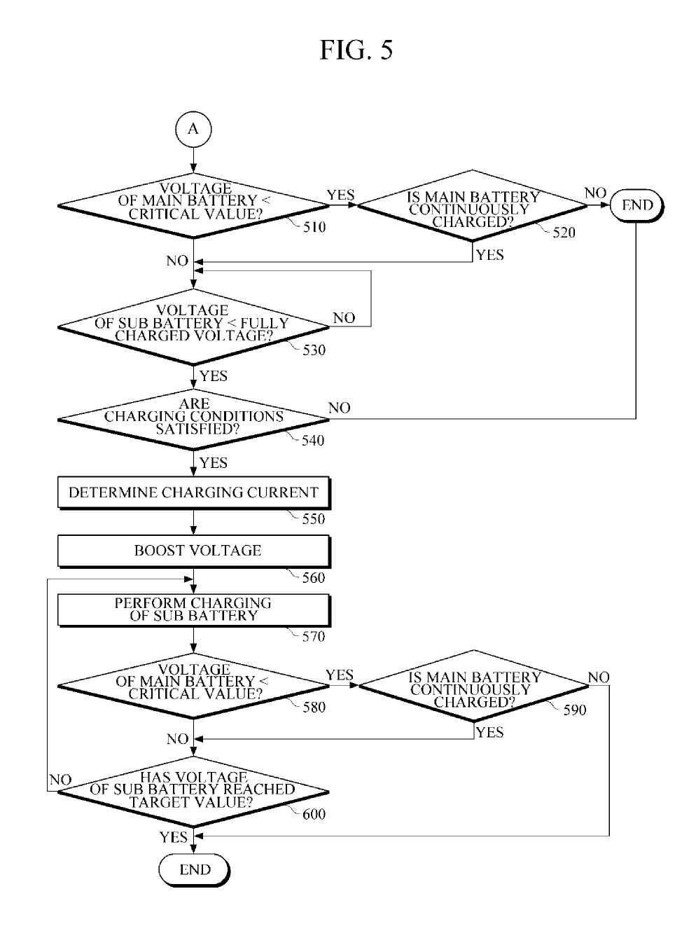

The control unit 16 may recognize the connection between the main terminal 10 and the charger 40, and may control the charging unit 11 to charge the main battery 12. The control unit 16 may recognize the connection between the main terminal 10 and the sub terminal 20 through the connection units 15 and 21, and control the sub terminal 20 to be charged. Further, the control unit 16 may control the boosting unit 14 to boost a voltage and/or a current so that the main battery 12 and the sub battery 22 can be simultaneously charged. Operations of the control unit 16 will be described in detail with reference to FIG. 3, FIG. 4, and FIG. 5.

The display unit 17 includes a display device, such as a liquid crystal display (LCD) a light emitting diode (LED) display, or the like, and may display the state of the main terminal 10 and/or the sub terminal 20, or the state of an executed program according to the control signal of the control unit 16. Further, the display unit 17 may display the recognition of the main battery 12 and the sub battery 22, and the charging states of each of the main battery 12 and the sub battery 22, etc. The control unit 16 may check the capacity of the main battery 12 and the capacity of the sub battery 22 and/or the integrated capacity of the main battery 12 and the sub battery 22, and display the checked state via the display unit 17. The display unit 17 may display an icon, a pop-up message, etc., which indicates aforementioned states of the main battery 12 and the sub battery 22. The pop-up message may indicate a low-voltage state, complete consumption state, etc. of the main battery 12 and/or the sub battery 22. As shown in FIG. 2, the display unit 17 and the input unit 19 may be implemented as separate components, or the display unit 17 and the input unit 19 may be implemented as an integrated user interface, such as a touch screen.

The memory 18 may store a program code to execute an algorithm for power control, user data, etc., including an application program for operating a charging control procedure. The memory 18 may store information on the battery capacity of the main battery 12 and the battery capacity of the sub battery 22. The memory area may be divided into a program storage area and a data storage area.

The storage space may store an operating system for booting the main terminal 10, an application program for other optional functions supported by the main terminal 10, e.g., a sound reproducing function or an image or moving-picture reproducing function, etc. The storage space may store a program for executing a power control algorithm for controlling the main battery 12 and the sub battery 22 to be efficiently operated according to the connection between the main battery 12 and the sub battery 22 and the capacity state of each of the main battery 12 and the sub battery 22.

The data area may store data generated by the main terminal 10. The data area may store, in real time or temporarily, information on the capacity state of the main battery 12 and the capacity state of the sub battery 22, and the stored information may be output to the display unit 17 under the control of the control unit 16.

The input unit 19 may provide an interface capable of receiving a user command, and may include, for example, a key input unit for generating key data when a key button is pressed by a user, a touch screen, a mouse, etc. Further, the input unit 19 may be linked with the display unit 17 so that information for processing of the control unit 16 is input from the user through the input unit 19. A user command indicating whether to charge the sub battery 22 using the remaining charge of the main battery 12 may be received through the input unit 19.

The sub terminal 20 includes a connection unit 21, a sub battery 22, and a power unit 23. The sub terminal 20 may not have a separate charging port, and may be charged through the charging unit 11 included in the main terminal 10. Thus, the sub battery 22 may be connected to the charging unit 11 through the connection units 15 and 21.

Similarly to the main battery 12, the sub battery 22 may be manufactured in a detachable form. Further, the sub battery 22 may be accommodated in a space of the sub terminal 20 or may be connected to an external connector of the sub terminal 20 in an attachable structure with respect to the sub terminal 20. The sub battery 22 may be charged by the charging unit 11 of the main terminal 10 through the connection units 15 and 21.

The power unit 23 may control power supplied to a component (not shown) of the sub terminal 20 by converting the remaining charge in the sub battery 22 into power. If a power key of the sub terminal 20 is pressed when the sub terminal 20 is turned off, the power unit 23 may provide the power supplied from the sub battery 22 to each component of the sub terminal 20. If the power key of the sub terminal 20 is pressed when the sub terminal 20 is turned on, the power unit 23 may stop the power supply by blocking the electrical signal line connected to the sub battery 22.

Hereinafter, a method for charging a sub terminal via a main terminal will be described and a method for charging the main terminal will be described.

FIG. 3 is a flowchart illustrating a method for charging a main terminal according to an exemplary embodiment of the present invention. FIG. 3 will be described as if performed by the main terminal 10 and/or the sub terminal 20 shown in FIG. 2, but is not limited as such.

Referring to FIG. 3, if the charger 40 is recognized by the control unit 16, the control unit 16 may determine whether the voltage of the main battery 12 is a fully charged voltage in operation 310.

If it is determined in operation 310 that the voltage of the main battery 12 is not the fully charged voltage, the control unit 16 may determine whether charging conditions are satisfied in operation 320. For example, the control unit 16 may check a charging temperature and check whether an abnormal event occurs in the main terminal 10 due to the charging of the main terminal 10.

If it is determined in operation 320 that the charging conditions are satisfied, the control unit 16 may determine charging current ‘Im’ for the main battery 12 in operation 330, and control the main battery 12 to be charged in operation 340. The control unit 16 may control the charging unit 11 to provide the charging current ‘Im’ to the main battery 12.

The control unit 16 may control the charging of the main battery 12 and may monitor the main battery 12 whether the voltage of the main battery 12 has reached the fully charged voltage in operation 350.

If it is determined in operation 350 that the voltage of the main battery 12 has not reached the fully charged voltage, the operation 340 may be performed again until the voltage of the main battery 12 reaches the fully charged voltage.

If it is determined in operation 350 that the voltage of the main battery 12 has reached the fully charged voltage, the control unit 16 may terminate the charging of the main battery 12.

Next, the method for charging a sub terminal using a main terminal will be described with reference to FIG. 4 and FIG. 5.

FIG. 4 is a flowchart illustrating a method for charging a sub terminal when a charger is coupled to a main terminal according to an exemplary embodiment of the present invention. FIG. 4 will be described as if performed by the main terminal 10 and/or the sub terminal 20 shown in FIG. 2, but is not limited as such.

Referring to FIG. 4, in operation 410, the control unit 16 may determine whether the sub battery 22 is recognized. The sub battery 22 may be recognized by the control unit 16 when the connection units 15 and 21 are connected. The connection of the sub terminal 22 may be recognized by detecting the voltage of the sub battery 22 through a connected physical pin. If the voltage of the sub battery corresponds to 0V, the control unit 16 may not recognize the sub battery 22. Thus, the control unit 16 may provide a small charging current to the sub battery 22 to determine whether the sub battery 22 is connected. If the charging current is provided in the sub terminal 20, the control unit 16 may determine that the sub battery 22 is connected and start charging of the sub battery 22. If the current is not charged in the sub terminal 20 even though the small charging current flows into the sub terminal 20, the control unit 16 may determine that the sub battery 22 is not connected to the sub terminal 20 and cut off the charging current.

If it is determined in operation 410 that the sub battery 22 has been recognized, the control unit 16 may determine whether the charger 40 is connected to the main terminal 10 in operation 420. If it is determined that the charger 40 is not connected to the main terminal 10 in operation 420, the operations of FIG. 5 may be performed.

If it is determined in operation 420 that the charger 40 is connected to the main terminal 10, the control unit 16 may determine whether the voltage of the sub battery 22 is less than a fully charged voltage level in operation 430.

If it is determined in operation 430 that the voltage of the sub battery 22 is less than the fully charged voltage level, the control unit 16 may determine whether charging conditions are satisfied in operation 440. The control unit 16 may determine whether the charging conditions of the sub terminal 20 are satisfied based on information stored in the memory 18.

If it is determined in operation 440 that the charging conditions are satisfied, the control unit 16 may determine the charging current ‘Is’ of the sub terminal 20 in operation 450.

In operation 460, the control unit 16 may boost a voltage to provide the charging current ‘Is’ for the sub battery 22 and the charging current ‘Im’ for the main battery 12. In operation 470, if the charging current ‘Is’ of the sub battery 22 is determined, a decrease in charging current for the main terminal 10 may be compensated by providing the main terminal with the charging current ‘Ims’ for the main terminal 10. The charging current ‘Ims’ for the main terminal 10 is obtained by adding the charging current ‘Is’ for the sub terminal 22 to the charging current ‘Im’ for the main battery 12. The charging current of the main terminal 10 may be maintained without a significant variation by designing the main terminal 10 so that the charging current for the main terminal 10 decreases according to a decrease in the charging current for the sub terminal 20 as the voltage of the sub terminal 20 reaches the fully charged voltage level.

If the mode of the sub terminal 20 is changed from a constant current mode (CCM) to a constant voltage mode (CVM), the charging current of the sub terminal 20 gradually decrease. In the CVM, the sub terminal 20 may be designed so that the charging current ‘Ims’ for the main terminal 10 decreases in the amount corresponding to a deceased amount of the charging current for the sub battery 22. Further, if the control unit 16 frequently monitors and checks the states of the main battery 12 and/or the sub battery 22 and controls the magnitude of the charging currents, more power consumption may occur. Thus, the control unit 16 may control the charging current ‘Ims’ by checking a change in the charging current of the sub terminal 20 periodically without adopting a real-time monitoring scheme.

Although not illustrated, the main battery 10 may be in a state of the fully charged voltage. If the main battery 10 is determined to be fully charged, the control unit 16 may stop charging of the main battery 12 and control only the sub battery 22 to be charged.

Further, the control unit 16 may control the display unit 17 to display remaining battery information of the main/sub terminal 10 and 20 by periodically checking the voltage of the main/sub terminal 10 and 20 using an internal timer.

In operation 480, the control unit 16 may determine whether the voltage of the sub terminal 20 reaches the fully charged voltage. If it is determined in operation 480 that the voltage of the sub terminal 20 has reached the fully charged voltage, the control unit 16 stop the charging of the sub battery 22. For example, the control unit 16 may turn off the boosting unit 14 to block the current path from the main terminal 10 to the sub terminal 20, and may inform the display unit 17 that the charging of the sub battery 22 has been completed.

If it is determined in operation 480 that the voltage of the sub battery 22 has not reached the fully charged voltage, the control unit 16 may perform operation 470 and perform the charging of the sub battery 22 until the sub battery 22 is fully charged.

If the voltage of the sub terminal 20 is less than the fully charged voltage level again, the control unit 16 may drive the boosting unit 14 again to charge the sub terminal 20 using the power of the main terminal 10.

If the remaining battery power of the main battery 12 or the charging voltage of the main battery 12 is less than a threshold remaining battery power or a threshold voltage by checking the remaining battery power or the charging voltage of the main battery 12, the control unit 16 may not perform charging of the sub terminal 20 even if the sub battery 22 of the sub terminal 20 is recognized. The charging of the sub terminal 20 from the main battery 12 may be initiated if the remaining battery power of the main battery 12 is greater than or equal to the threshold remaining battery power or the charging voltage of the main battery 12 is greater than or equal to the threshold voltage.

FIG. 5 is a flowchart illustrating a method for charging a sub terminal when a charger is not coupled to a main terminal according to an exemplary embodiment of the present invention. FIG. 5 will be described as if performed by the main terminal 10 and/or the sub terminal 20 shown in FIG. 2, but is not limited as such. Further, operations 410 and 420 may be performed before determining to perform operation 510, but aspects are not limited thereto. Thus, the operation 410 and/or the operation 420 may not be performed before determining to perform operation 510.

The charging capacity of the main terminal 10 may be relatively greater than that of the sub terminal 20. Therefore, if the voltage of the sub terminal 20 decreases below a threshold voltage, or in order to maintain the voltage of the sub terminal 20 to be greater than or equal to a threshold voltage, the sub terminal 20 may be charged using the main terminal 10 even the charger 40 is not connected to the main terminal 10.

Referring to FIG. 5, the control unit 16 may determine whether the voltage of the main battery 12 is less than or equal to a critical value in operation 510. If it is determined in operation 510 that the voltage of the main battery 12 is less than or equal to the critical value, the control unit 16 may determine whether the main battery 12 is charging from the charger 40 in operation 520. The control unit 16 may determine charging of the main battery 12 by checking whether the charger 40 is connected, or may receive information on charging of the main battery 12 inputted from a user through the input unit 19.

If it is determined in operation 520 that the main battery 12 is to be charged, the control unit 16 performs operation 530 and performs the charging of the main battery 12.

If it is determined in operation 520 that the charging of the main battery 12 does not occur, the control unit 16 may turn off the boosting unit 14 and cut off the path through which the charging current of the sub terminal 20 flows.

If it is determined in operation 510 that the voltage of the main battery 12 is greater than the critical value, the control unit 16 may determine whether the voltage of the sub battery 12 is less than or equal to fully charged voltage level.

If it is determined in operation 530 that the voltage of the sub battery 12 is less than or equal to the fully charged voltage level, the control unit 16 may determine whether charging conditions are satisfied.

If it is determined in operation 540 that the charging conditions are satisfied, the control unit 16 may determine the charging current ‘Is’ for the sub terminal 20.

The control unit 16, in operation 560, may boost a voltage to provide the sub battery 22 with the charging current ‘Is’, and charge the sub battery 22 in operation 570.

In operation 580, the control unit 16 may determine whether the voltage of the main battery 12 is less than or equal to the critical value. If it is determined in operation 580 that the voltage of the main battery 12 is less than or equal to the critical value, the control unit 16 may determine whether the main battery 12 is connected to the charger 40 to be charged. The voltage across the main battery 12 may be used as the voltage across the sub battery 22 so that although the driving of the main battery 12 is difficult, the control unit 16 may determine whether the sub battery 22 is to be charged. The charging of the sub battery 22 may be determined by information input from a user through the input unit 19.

If it is determined in operation 590 that the main battery 12 is not connected to the charger 40 to be continuously charged, the control unit 16 may stop the charging of the sub battery 22. The control unit 16 may turn off the boosting unit 14 to block the current path from the main terminal 10 to the sub terminal 20, and may inform the display unit 17 that the charging of the sub battery 22 has been terminated.

If it is determined in operation 580 that the voltage of the main battery 12 is greater than the critical value, the control unit 16 may determine whether the voltage of the sub battery 22 has reached a target value. If it is determined in operation 600 that the voltage of the sub battery 22 has not reached the target value, the control unit 16 performs operation 570 and performs the charging of the sub battery 22. If it is determined in operation 600 that the voltage of the sub battery 22 has reached the target value, the control unit 16 may stop the charging of the sub battery 22.

According to aspects of the present invention, since a plurality of batteries are simultaneously charged in a main terminal and an attachable/detachable sub terminal, a separate charger for charging each of the batteries may be eliminated.

Further, the battery of the sub terminal is charged using the relatively high-capacity battery of the main terminal, so that the battery of the sub terminal can be charged from the main terminal when a charger cannot be connected to the main terminal.

Aspects of the present invention can be implemented as computer readable codes in a non-transitory computer readable record medium. The computer readable record medium includes all types of record media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A main terminal, comprising:
a connection unit connectable to a subordinate terminal;
a charging unit to charge a first battery of the main terminal, and to charge a second battery of the subordinate terminal; and
a control unit to maintain a first charging current to the main terminal regardless of whether a second charging current is provided to the subordinate terminal.

2. The main terminal of claim 1, wherein the control unit controls the second charging current provided to the subordinate terminal according to a state of the second battery of the subordinate terminal.

3. The main terminal of claim 2, wherein the control unit checks the state of the second battery by measuring a voltage of the second battery periodically.

4. The main terminal of claim 1, further comprising: a boosting unit to boost a voltage to provide the second charging current if the control unit recognizes the second battery.

5. The main terminal of claim 1, further comprising: a display unit to display a first charging state of the first battery and a second charging state of the second battery.

6. The main terminal of claim 1, wherein the control unit determines to provide the subordinate terminal with the second charging current if the first battery has a remaining battery power greater than a first threshold value.

7. The main terminal of claim 1, wherein the connection unit comprises a first pin to detect a temperature of the subordinate terminal.

8. The main terminal of claim 1, wherein the control unit checks whether a charging condition for the subordinate terminal is satisfied based on at least one of a temperature check and an abnormal event check for the subordinate terminal.

9. The main terminal of claim 1, wherein the charging unit provides the second charging current to determine whether the second battery is connected if the second battery is not recognized.

10. A main terminal, comprising:
a connection unit connectable to a subordinate terminal;
a charging unit to charge a first battery of the main terminal, and to charge a second battery of the subordinate terminal; and
a control unit to provide a charging current to the subordinate terminal if a remaining battery power of the first battery is greater than a threshold battery power.

11. The main terminal of claim 10, further comprising: a boosting unit to boost a voltage to provide the charging current if the control unit recognizes the second battery.

12. The main terminal of claim 10, further comprising: a display unit to display a first charging state of the first battery and a second charging state of the second battery.

13. The main terminal of claim 10, wherein the connection unit comprises a first pin to detect a temperature of the subordinate terminal.

14. The main terminal of claim 13, wherein the control unit checks whether a charging condition for the subordinate terminal is satisfied according to a temperature check for the subordinate terminal using the first pin.

15. A method for controlling a charging current for a subordinate terminal connected to a main terminal, comprising:
recognizing a voltage of a battery of the subordinate terminal;
determining a charging current for the battery of the subordinate terminal; and
providing the charging current to the battery if the voltage of the battery is less than or equal to a target voltage.

16. The method of claim 15, further comprising: controlling the charging current provided to the subordinate terminal while maintaining a charging current provided to the main terminal.

17. The method of claim 15, further comprising: checking a state of the battery by measuring the voltage of the battery periodically.

18. The method of claim 15, further comprising: displaying a charging state of the battery of the subordinate terminal.

19. The method of claim 15, further comprising: determining to provide the subordinate terminal with the second charging current if the first battery has a remaining battery power greater than a first threshold value.

20. The method of claim 15, further comprising: determining a charging condition for the subordinate terminal is satisfied based on at least one of a temperature check and an abnormal event check for the subordinate terminal.
